(19) United States
(12) Patent Application Publication
(10) Pub. No.: US 2015/0328965 A1
(43) Pub. Date: Nov. 19, 2015

(54) EXTENSION ASSEMBLY FOR A SIDEBAR OF A SUNSHADE

(71) Applicant: MACAUTO INDUSTRIAL CO., LTD., Tainan City (TW)

(72) Inventors: Paul LIN, Tainan City (TW); Chi-Tsai FANG, Tainan City (TW)

(73) Assignee: MACAUTO INDUSTRIAL CO., LTD., Tainan City (TW)

(21) Appl. No.: 14/278,282

(22) Filed: May 15, 2014

(51) Int. Cl. B60J 1/20

(52) U.S. Cl. CPC B60J 1/2044; B60J 1/2022

(57) ABSTRACT

An extension assembly for a sidebar of a sunshade is mounted on a mounting ends of a movable sidebar and has a mounting seat, a sliding cover, at least one linkage, and a connector. The movable sidebar is attached to an end edge of a shading cloth of a sunshade. With the at least one linkage pivotally connected to the mounting seat and the sliding cover, the at least one linkage can pivot and sway to allow the sliding cover being raised and then lowered to selectively extend toward the outer end portion of the mounting seat and be folded on the mounting seat. Thus, frictional resistance between the mounting seat and the sliding cover is avoided. Moreover, no noises would occur when the at least one linkage and the sliding cover pivot and sway relative to the mounting seat.

### BACKGROUND OF THE INVENTION

1. Field of the Invention

The present invention relates to an extension assembly, especially to an extension assembly that is mounted on an end of a movable sidebar of the sunshade, such that a total length of the movable sidebar and the extension assembly can be adjusted.

2. Description of the Prior Art(s)

In order for a vehicle with better appearance and elegance, a reeling device and a driving mechanism of an electrical sunshade for mounting on a rear windshield of the vehicle are mounted under a dividing panel. The dividing panel is mounted on a lower edge of the rear windshield and has a slot. Two guiding rails are respectively mounted on two opposite side edges of the rear windshield. A shading cloth of the reeling device protrudes through the slot of the dividing panel and has a distal edge. A movable sidebar is attached to the distal edge of the shading cloth and has two opposite ends. The ends of the movable sidebar respectively engage in the guiding rails and are connected to a guiding rod of the driving mechanism. The guiding rod of the driving mechanism drives the movable sidebar to move upwardly to draw and to expand the shading cloth, or drives the movable sidebar to move downwardly to retract the shading cloth.

When the shading cloth is retracted, the movable sidebar is unable to completely cover the slot of the dividing panel. Therefore, two conventional extension assemblies for a sidebar are further mounted respectively on the ends of the movable sidebar. The conventional extension assemblies are connected to the guiding rod of the driving mechanism. Thus, when the shading cloth is retracted, the conventional extension assemblies extend laterally to completely cover the slot of the dividing panel. When the shading cloth is expanded, the conventional extension assemblies are retracted.

However, each conventional extension assembly has a sliding cover mounted on a corresponding one of the ends of the movable sidebar. The sliding cover slides linearly along an axis to extend or to retract the conventional extension assembly. As the sliding cover slides linearly, a large friction is generated between the sliding cover and its peripheral elements. Accordingly, loud noise occurs when the conventional extension assemblies are operated.

To overcome the shortcomings, the present invention provides an extension assembly for a sidebar of a sunshade to mitigate or obviate the aforementioned problems.

### SUMMARY OF THE INVENTION

The main objective of the present invention is to provide an extension assembly for a sidebar of a sunshade. The extension assembly has a mounting seat, a sliding cover, at least one linkage, and a connector. The mounting seat has a mounting section. The mounting section has at least one first pivot portion. The sliding cover is slidably mounted on the mounting seat and has a cover body, a connecting portion, and at least one second pivot portion. The connecting portion is formed on an outer end of the cover body. The at least one second pivot portion is formed on a lower surface of the cover body. Each one of the at least one linkage has two opposite pivot end portions. The pivot end portions are respectively connected pivotally to a corresponding one of the at least one first pivot portion of the mounting seat and a corresponding one of the at least one second pivot portion of the sliding cover. The connector is connected to the connecting portion of the sliding cover and is disposed beyond the outer end portion of the mounting seat. When the at least one linkage pivots and sways laterally, the sliding cover is raised and then lowered to selectively extend toward the outer end portion of the mounting seat and be folded on the mounting seat.

Two above-mentioned extension assemblies are respectively mounted on two mounting ends of a movable sidebar. The movable sidebar is attached to an end edge of a shading cloth of a sunshade. With the at least one linkage pivotally connected to the mounting seat and the sliding cover, the at least one linkage can pivot and sway to allow the sliding cover being raised and then lowered to selectively extend toward the outer end portion of the mounting seat and be folded on the mounting seat. Thus, friction between the sliding cover and the mounting seat is reduced. Accordingly, frictional resistance between the mounting seat and the sliding cover is avoided. Moreover, no noises would occur when the at least one linkage and the sliding cover pivot and sway relative to the mounting seat.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of an extension assembly for a sidebar of a sunshade in accordance with the present invention, shown with two extension assemblies mounted on two ends of a movable sidebar;

FIG. 2 is an operational exploded perspective view of the extension assembly in FIG. 1;

FIG. 3 is an exploded perspective view of a sliding cover and a connector of the extension assembly in FIG. 1;

FIG. 4 is an operational perspective view of the extension assembly in FIG. 1;

FIG. 5 is an operational top view of the extension assembly in FIG. 1;

FIG. 6 is an operational cross-sectional side view of the extension assembly along line 6-6 in FIG. 5;

FIG. 7 is an operational side view of the extension assembly in FIG. 1, shown with a shading cloth of the sunshade being expanded;

FIGS. 8 and 9 are operational cross-sectional side views of the extension assembly in FIG. 1, shown with a sliding cover of the extension assembly being raised to move inwardly to be folded;

FIG. 10 is an operational side view of the extension assembly in FIG. 1, shown with the shading cloth of the sunshade being retracted; and

FIGS. 11 and 12 are operational cross-sectional side views of the extension assembly in FIG. 1, shown with the sliding cover of the extension assembly being raised to move outwardly to extend.

### DETAILED DESCRIPTION OF THE PREFERRED EMBODIMENTS

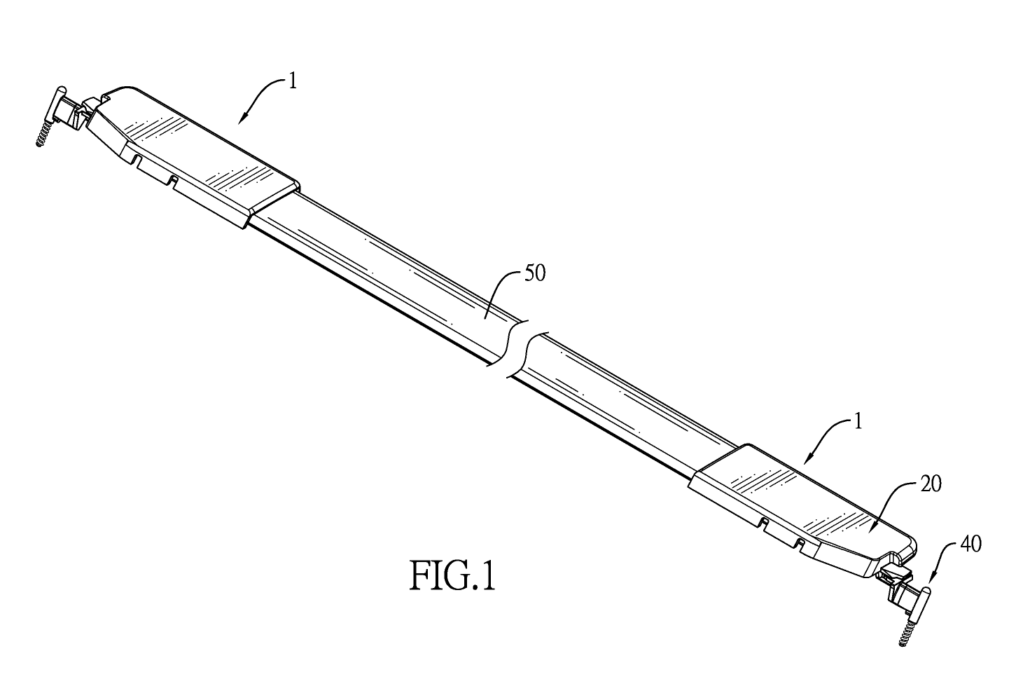

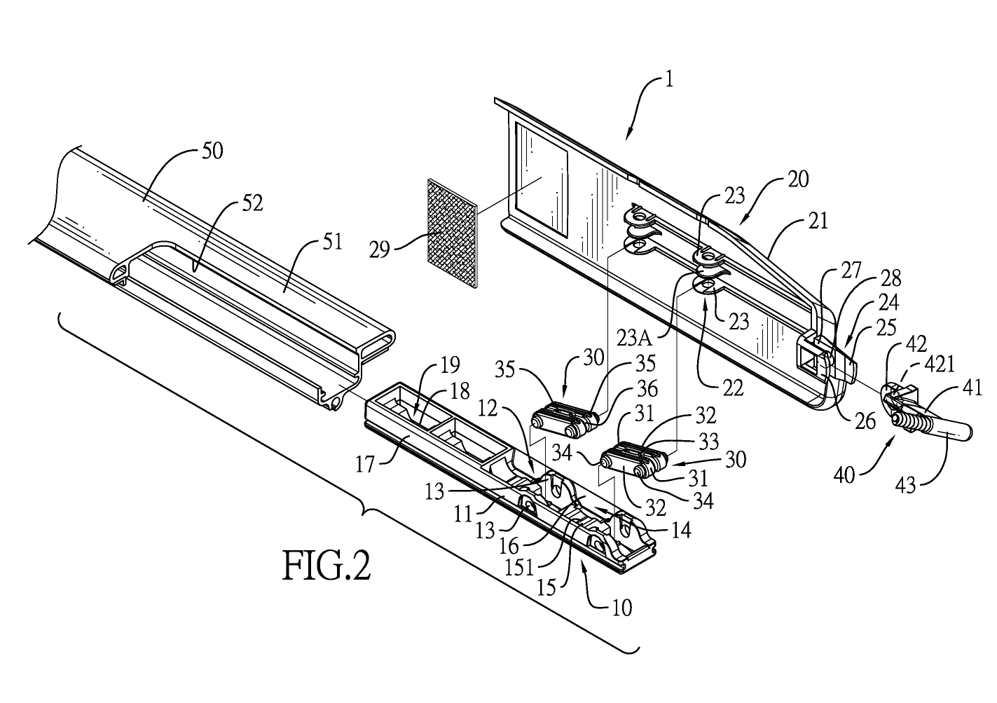

With reference to FIGS. 1 and 2, a movable sidebar 50 is used to attach to an end edge of a shading cloth of a sunshade, and has a central axis and two mounting ends 51. Each mounting end 51 has a notch 52. An extension assembly 1 for a sidebar of the sunshade in accordance with the present invention is mounted on the mounting end 51 of the movable sidebar 50, and selectively pivots and sways to move along the central axis of the movable sidebar 50 to be extended or to be folded. The extension assembly 1 comprises a mounting seat 10, a sliding cover 20, at least one linkage 30, and a connector 40.

As shown in FIG. 2, the mounting seat 10 is mounted on the end of the movable sidebar 50 of the sunshade and has an axis, an outer end portion, an inner end portion and a mounting section 11. The axis of the mounting seat 10 extends through the outer end portion and the inner end portion of the mounting seat 10 and is parallel to the central axis of the movable sidebar 50. The mounting section 11 is formed on the outer end portion of mounting seat 10 and has at least one first pivot portion 12. Each one of the at least one first pivot portion 12 has two first pivot protrusions 13. The first pivot protrusions 13 are disposed opposite to each other. Each first pivot protrusion 13 has a pivot hole.

As shown in FIG. 2, in the preferred embodiment, the mounting section 11 of the mounting seat 10 has two first pivot portions 12. The first pivot portions 12 are linearly arranged along the axis of the mounting seat 10. Each first pivot portion 12 further has a sliding space 14 and a resilient positioning member 15. The first pivot protrusions 13 of each first pivot portion 12 are oppositely formed beside the sliding space 14. The resilient positioning member 15 is mounted between the first pivot protrusions 13 that are disposed opposite to each other.

As shown in FIG. 2, in the preferred embodiment, each first pivot portion 12 further has two positioning fins 16. The positioning fins 16 are formed oppositely beside the sliding space 14. Each positioning fin 16 has a thickness. The thickness of the positioning fin 16 increases from top to bottom, such that a width of the sliding space 14 enlarges from bottom to top.

As shown in FIG. 2, the mounting seat 10 further has a connecting section 17. The connecting section 17 is formed on the inner end portion of the mounting seat 10, is mounted into the mounting end 51 of the movable sidebar 50, and has at least one resilient abutting member 18. With further reference to FIG. 6, the connecting section 17 protrudes into the movable sidebar 50 and the at least one resilient abutting member 18 abuts an inner wall of the movable sidebar 50. Thus, when the sunshade is expanded or is folded, the mounting seat 10 can slide slightly relative to the movable sidebar 50, such that dimensional tolerances of the movable sidebar 50 and the mounting seat 10 are acceptable. In the preferred embodiment, the connecting section 17 further has multiple mounting recesses 19. The mounting recesses 19 are linearly arranged along the axis of the mounting seat 10. Each mounting recess 19 has a top opening and a bottom opening. The connecting section 17 has multiple resilient abutting members 18 respectively mounted in the mounting recesses 19. Each resilient abutting member 18 protrudes out from one of the top opening and the bottom opening, and resilient abuts the inner wall of the movable sidebar 50, such that the mounting seat 10 is held in the movable sidebar 50.

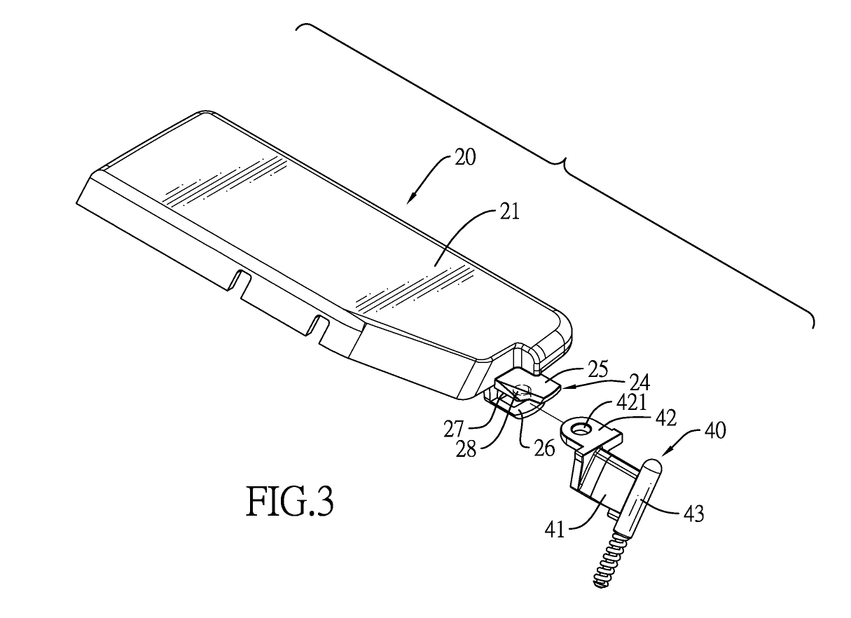

With reference to FIGS. 2 and 3, the sliding cover 20 is slidably mounted on the mounting seat 10 and the outer end portion of the movable sidebar 50. The sliding cover 20 has a cover body 21, at least one second pivot portion 22, and a connecting portion 24. The cover body 21 has an inner end, an outer end, an axis, and a lower surface. The axis of the cover body 21 extends through the inner end and the outer end of the cover body 21 and is parallel to the central axis of the movable sidebar 50. The lower surface of the cover body 21 faces the mounting seat 10 and the movable sidebar 50. The at least one second pivot portion 22 is formed on the lower surface of the cover body 21. The number of the at least one second pivot portion 22 corresponds to the number of the at least one first pivot portion 12. The connecting portion 24 of the sliding cover 20 is formed on the outer end of the cover body 21 and extends beyond the outer end portion of the mounting seat 10 and the end of the movable sidebar 50. In the preferred embodiment, the sliding cover 20 further has a cushion pad 29. The cushion pad 29 is mounted on the lower surface of the cover body 21, and may be made of non-woven fabrics. Thus, when the sliding cover 20 collides with the movable sidebar 50, the cushion pad 29 absorbs a collision between the sliding cover 20 and the movable sidebar 50. Accordingly, noise caused by the collision can be reduced.

As shown in FIGS. 2 and 3, in the preferred embodiment, the sliding cover 20 has two second pivot portions 22. The second pivot portions 22 are linearly arranged along the axis of the cover body 21. Each second pivot portion 22 has two second pivot protrusions 23. The second pivot protrusions 23 are disposed opposite to each other. Each second pivot protrusion 23 has a pivot hole. The connecting portion 24 of the sliding cover 20 has a first connecting panel 25, a second connecting panel 26, an insertion slot 27, and an engaging protrusion 28. The first connecting panel 25 has a proximal end, a distal end, and an inner surface. The second connecting panel 26 corresponds in position to and is disposed apart from the first connecting panel 25. The second connecting panel 26 has a proximal end, a distal end, and an inner surface. The proximal end of the second connecting panel 26 is connected with the proximal end of the first connecting panel 25. The inner surface of the second connecting panel 26 faces the inner surface of the first connecting panel 25. The insertion slot 27 is formed between the first connecting panel 25 and the second connecting panel 26, and has an insertion hole. The insertion hole of the insertion slot 27 is defined between the distal ends of the first connecting panel 25 and the second connecting panel 26. Thus, the connecting portion 24 of the sliding cover 20 can be resiliently expanded and restored. The engaging protrusion 28 is formed on one of the inner surfaces of the first connecting panel 25 and the second connecting panel 26. In the preferred embodiment, the engaging protrusion 28 is formed on the inner surface of the first connecting panel 25.

With reference to FIGS. 2 and 6, each one of the at least one linkage 30 has two opposite pivot end portions 31. The pivot end portions 31 are respectively connected pivotally to a corresponding one of the at least one first pivot portion 12 of the mounting seat 10 and a corresponding one of the at least one second pivot portion 22 of the sliding cover 20. Each pivot end portion 31 has two opposite ends and two pivot protrusions 34. The pivot protrusions 34 of the pivot end portion 31 are respectively formed on the ends of the pivot end portion 31 and are respectively mounted pivotally in the pivot holes of the corresponding pivot portion 12, 22. As the at least one linkage 30 pivots and sways, the sliding cover 20 slides axially above the outer end portion of the mounting seat 10 to selectively extend outwardly and be folded inwardly. Moreover, with the thickness of each positioning fin 16 increasing from the top to the bottom, when the sliding cover 20 is folded on the mounting seat 10, the sliding cover 20 is also held by the positioning fins 16 of the mounting seat 10.

As shown in FIG. 2, in the preferred embodiment, the extension assembly 1 comprises two linkages 30. Each linkage 30 has two rod parts 32, a connecting part 33, and two clearances 36. The two rod parts 32 are disposed parallel to each other. Each rod part 32 has a first end and a second end. The first end of one rod part 32 corresponds in position to the first end of the other rod part 32. The second end of one rod part 32 corresponds in position to the second end of the other rod part 32. The connecting part 33 connects the rod parts 32. The clearances 36 are respectively formed between the first ends of the rod parts 32 and between the second ends of the rod parts 32. Each second pivot portion 22 of the sliding cover 20 further has an engaging panel 23A. The engaging panel 23A is formed between the second pivot protrusions 23 of the second pivot portion 22 and protrudes into one of the clearances 36 of the corresponding linkage 30. Thus, the sliding cover 20 stably connects with the linkages 30. When the sliding cover 20 extends or is folded, vibration of the sliding cover 20 is greatly reduced.

As shown in FIGS. 2 and 6, each pivot end portion 31 of each one of the at least one linkage 30 has two side surfaces. Each side surface has at least one engaging recess 35. In the preferred embodiment, each side surface of each pivot end portion 31 of each one of the at least one linkage 30 has two engaging recesses 35. The resilient positioning member 15 of each first pivot portion 12 of the mounting seat 10 has an abutting protrusion 151. The abutting protrusion 151 is formed on a top surface of the resilient positioning member 15, selectively engages in one of the engaging recesses 35 of the corresponding pivot end portion 31, and abuts the corresponding pivot end portion 31. As the linkage 30 pivots and sways to a predetermined position, with the abutting protrusion 151 engaging in the engaging recess 35, the linkage 30 is held at the predetermined position. Accordingly, the linkage 30 can be held at two predetermined positions.

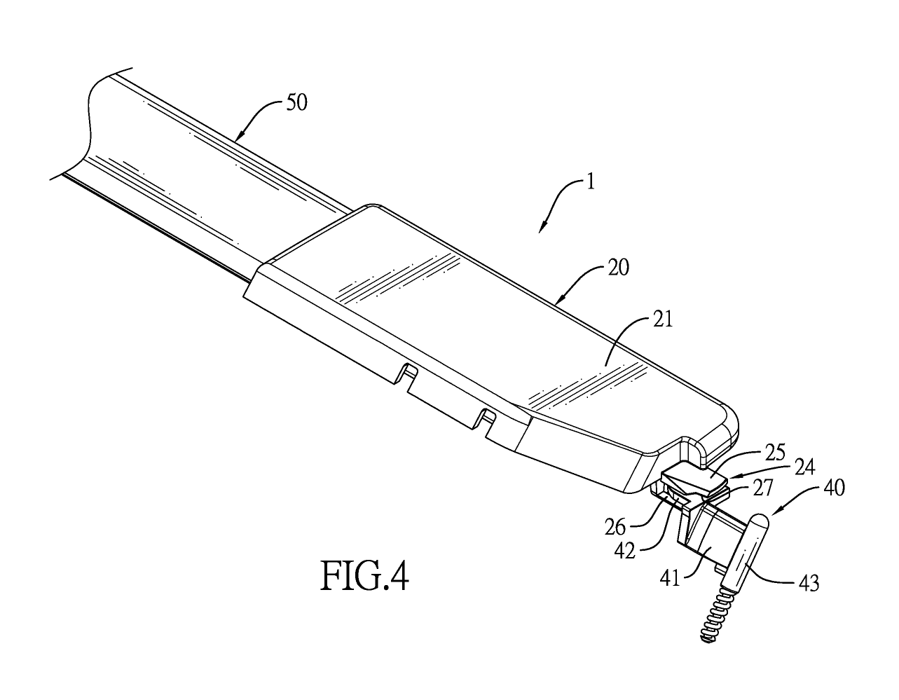

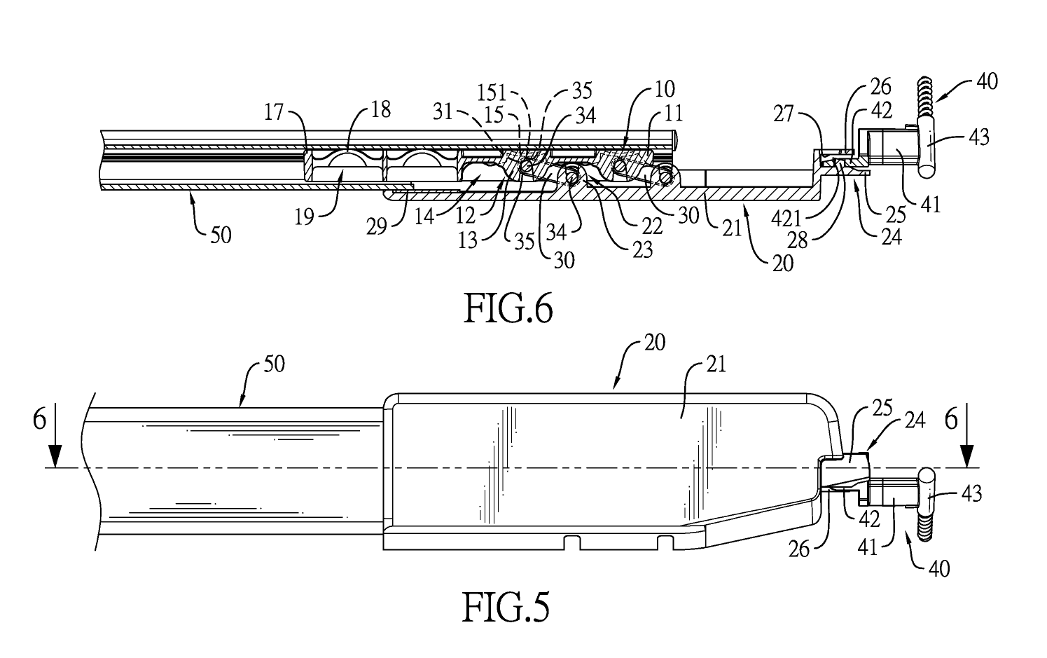

With reference to FIGS. 2 and 4, the connector 40 is connected to the sliding cover 20, and is disposed beyond the mounting end 51 of the movable sidebar 50 and the outer end portion of the mounting seat 10. The connector 40 has a guiding portion 41, a proximal connecting portion 42, and a distal connecting portion 43. The guiding portion 41 has two ends. The proximal connecting portion 42 is formed on one of the ends of the guiding portion 41 and is connected to the connecting portion 24 of the sliding cover 20. The distal connecting portion 43 is formed on the other end of the guiding portion 41. As shown in FIGS. 2, 3, and 4, in the preferred embodiment, the proximal connecting portion 42 is inserted in the insertion slot 27 of the connecting portion 24 of the sliding cover 20, and has a plate with an engaging hole 421. As shown in FIGS. 4 and 6, the engaging protrusion 28 engages in the engaging hole 421, such that the proximal connecting portion 42 of the connector 40 is connected to the connecting portion 24 of the sliding cover 20. The distal connecting portion 43 has a threaded part.

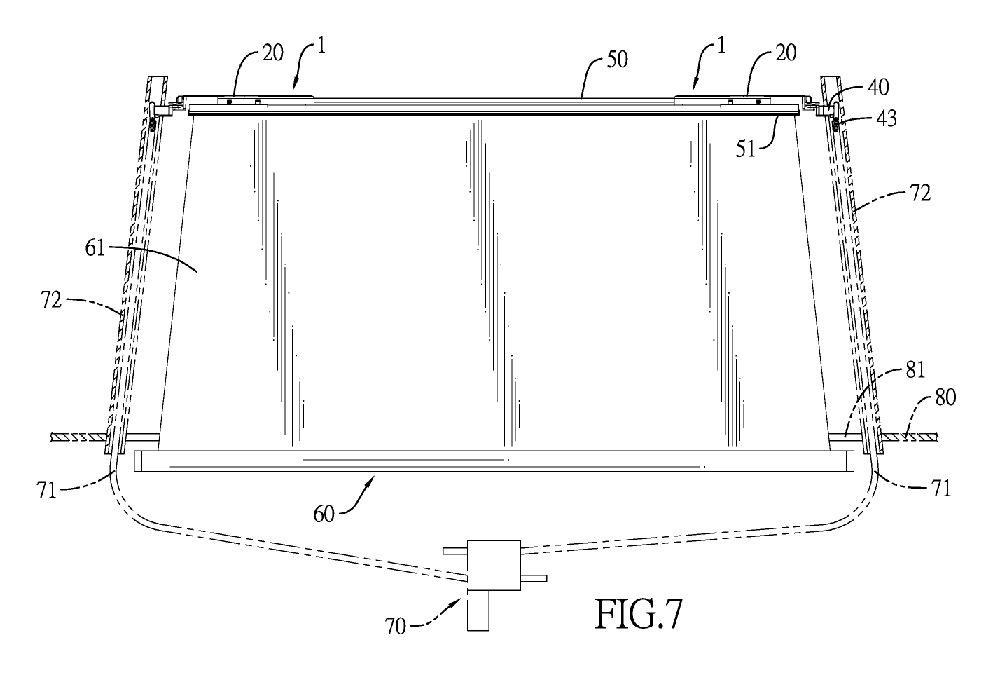

With reference to FIG. 7, when the extension assembly 1 is used on an electrical sunshade that is mounted on a rear windshield of a vehicle, an end edge of a shading cloth 61 of the electrical sunshade is attached to the movable sidebar 50 Two extension assemblies 1 are respectively mounted on the mounting ends 51 of the movable sidebar 50. As shown in FIGS. 2 and 7, the electrical sunshade further has two guiding rails 72 and a driving mechanism 70. The guiding rails 72 are respectively formed on two opposite side edges of the rear windshield. The driving mechanism 70 has two guiding rods 71 respectively protruding in the guiding rails 72. The mounting seat 10 of each extension assembly 1 is mounted in a corresponding one of the mounting ends 51 of the movable sidebar 50. The guiding portion 41 of the connector 40 of each extension assembly 1 protrudes into a corresponding one of the guiding rails 72. The threaded distal connecting portion 43 of the connector 40 is connected to the guiding rod 71.

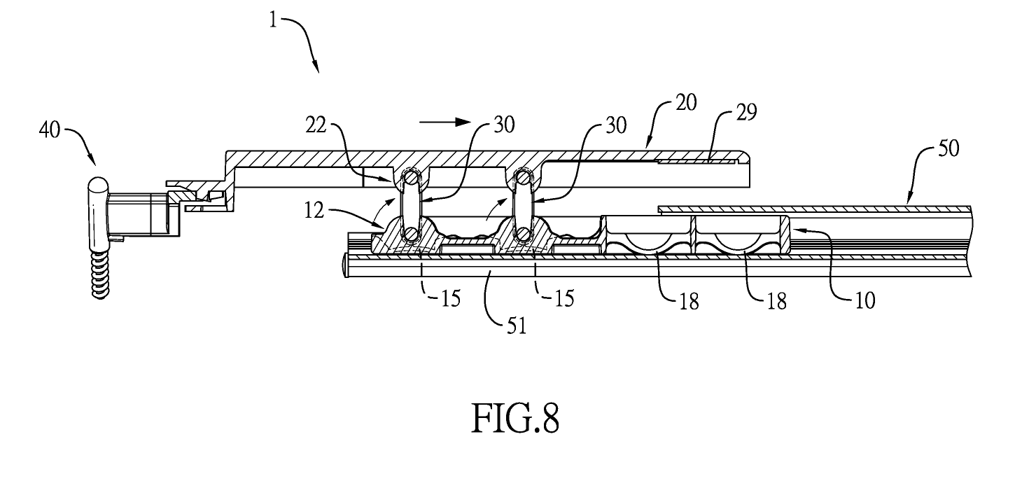

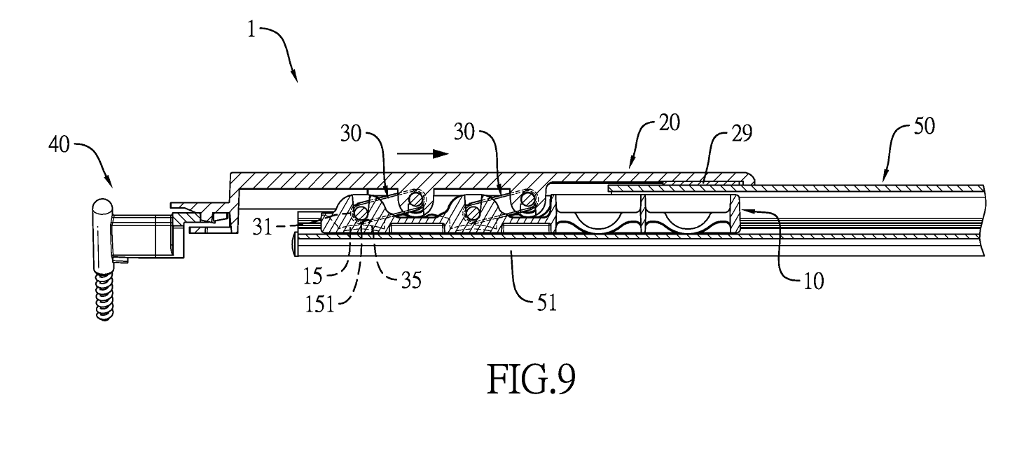

With reference to FIG. 7, when the shading cloth 61 of the electrical sunshade is expanded, the driving rod 71 of the driving mechanism 70 drives the movable sidebar 50 and the extension assemblies 1 to move upwardly to a top of the rear windshield. Meanwhile, the shading cloth 61 is draw out from a reeling device 60 and is expanded. With further reference to FIGS. 8 and 9, during the shading cloth 61 is expanded, the sliding cover 20 is pushed inwardly toward the movable sidebar 50 since the connector 40 is connected to the guiding rod 71. Accordingly, the at least one linkage 30 connecting to the sliding cover 20 and the mounting seat 10 pivots and sways inwardly toward the movable sidebar 50. Thus, at first, the sliding cover 20 is raised up from the mounting seat 10 and the movable sidebar 50. Then the sliding cover 20 is lowered to be folded on the mounting seat 10 and the mounting end 51 of the movable sidebar 50.

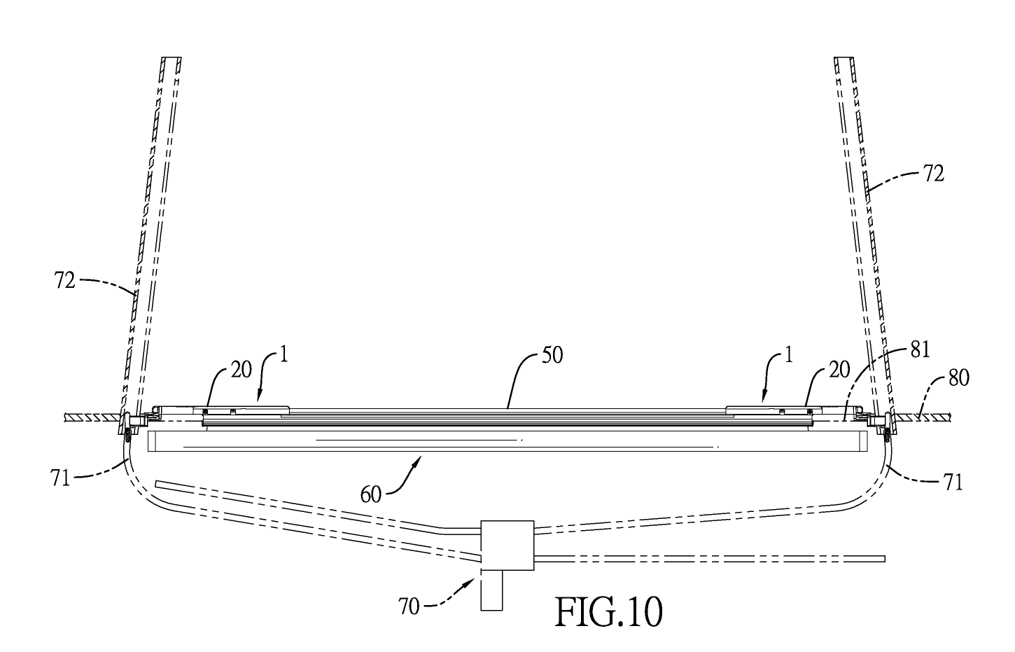

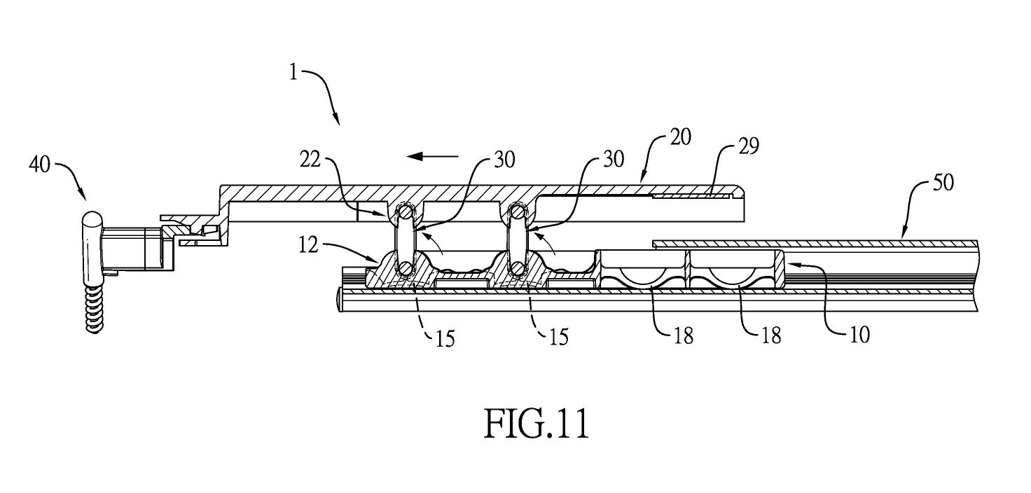

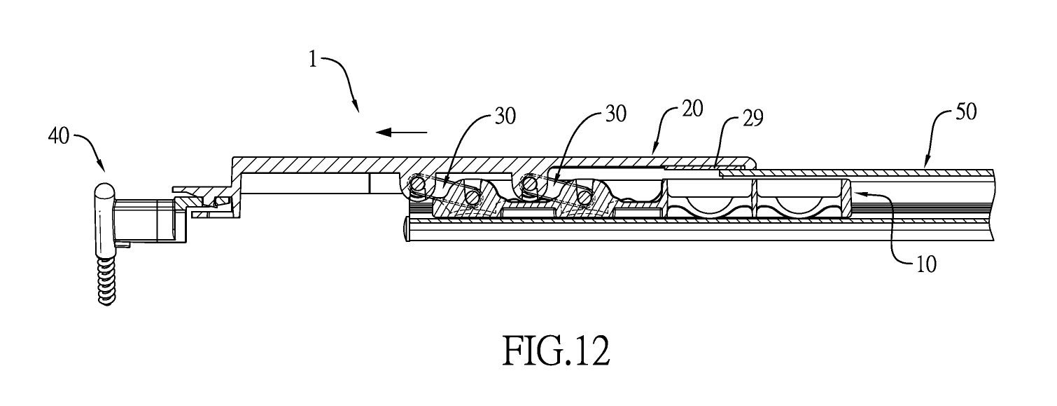

With reference to FIG. 10, when retracting the shading cloth 61 of the electrical sunshade, the driving rod 71 of the driving mechanism 70 is driven to drive the movable sidebar 50 and the extension assemblies 1 to move downwardly to a bottom of the rear windshield. Meanwhile, the reeling device 60 rolls up the shading cloth 61 automatically. With further reference to FIGS. 11 and 12, during retracting the shading cloth 61, since the connector 40 is connected to the guiding rod 71, the sliding cover 20 is pulled outwardly. Accordingly, the at least one linkage 30 that connects to the sliding cover 20 and the mounting seat 10 pivots and sways outwardly. Thus, at first, the sliding cover 20 is raised up from the mounting seat 10 and the movable sidebar 50. Then the sliding cover 20 is lowered to lie on the mounting seat 10 and the mounting end 51 of the movable sidebar 50 and to extend beyond the outer end portion of the mounting seat 10. Therefore, the extension assemblies 1 on two mounting ends 51 of the movable sidebar 50 extend to cover two clearances of a slot 81 of a dividing panel 80, wherein the clearances are formed between the mounting ends 51 of the movable sidebar 50 and the guiding rails 71.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An extension assembly for a sidebar of a sunshade comprising:
a mounting seat having
an outer end portion;
an inner end portion; and
a mounting section having at least one first pivot portion;
a sliding cover slidably mounted on the mounting seat, and the sliding cover having
a cover body having an outer end and a lower surface;
a connecting portion formed on the outer end of the cover body; and
at least one second pivot portion formed on the lower surface of the cover body;
at least one linkage, each one of the at least one linkage having two opposite pivot end portions, and the pivot end portions respectively connected pivotally to a corresponding one of the at least one first pivot portion of the mounting seat and a corresponding one of the at least one second pivot portion of the sliding cover; and
a connector connected to the connecting portion of the sliding cover and disposed beyond the outer end portion of the mounting seat;
wherein when the at least one linkage pivots and sways laterally, the sliding cover is raised and then lowered to selectively extend toward the outer end portion of the mounting seat and be folded on the mounting seat.

2. The extension assembly for the sidebar as claimed in claim 1, wherein each one of the at least one first pivot portion of the mounting section of the mounting seat has a resilient positioning member, the resilient positioning member abuts a corresponding one of the pivot end portions of a corresponding one of the at least one linkage.

3. The extension assembly for the sidebar as claimed in claim 2, wherein
each pivot end portion of each one of the at least one linkage has two side surfaces, and each side surface has at least one engaging recess; and
the resilient positioning member has an abutting protrusion formed on a top surface of the resilient positioning member, selectively engaging in one of the engaging recesses of the corresponding pivot end portion, and abutting the corresponding pivot end portion.

4. The extension assembly for the sidebar as claimed in claim 1, wherein
the mounting section of the mounting seat has multiple first pivot portions linearly arranged on the mounting seat, and each first pivot portion has
a sliding space; and
two first pivot protrusions oppositely formed beside the sliding space;
the sliding cover has multiple second pivot portions linearly arranged on the lower surface of the cover body, and each second pivot portion has two second pivot protrusions disposed opposite to each other; and
the extension assembly for the sidebar comprises multiple linkages, and the pivot end portions of each linkage are respectively connected pivotally to the corresponding first pivot portion of the mounting seat and the corresponding second pivot portion of the sliding cover.

5. The extension assembly for the sidebar as claimed in claim 4, wherein
each linkage has
two rod parts disposed parallel to each other, and each rod part having two ends;
a connecting part connecting the rod parts; and
two clearances respectively formed between the ends of the rod parts;
each second pivot portion of the sliding cover further has an engaging panel formed between the second pivot protrusions of the second pivot portion and protruding into one of the clearances of the corresponding linkage.

6. The extension assembly for the sidebar as claimed in claim 3, wherein
the mounting section of the mounting seat has multiple first pivot portions linearly arranged on the mounting seat, and each first pivot protrusion has
a sliding space; and
two first pivot protrusions oppositely disposed beside the sliding space;
the sliding cover has multiple second pivot portions linearly arranged on the lower surface of the cover body, and each second pivot protrusion has two second pivot protrusions disposed opposite to each other;
the extension assembly for the sidebar comprises multiple linkages, the pivot end portions of each linkage are respectively connected pivotally to the corresponding first pivot portion of the mounting seat and the corresponding second pivot portion of the sliding cover, and each linkage has
two rod parts disposed parallel to each other, and each rod part having two ends;
a connecting part connecting the rod parts; and
two clearances respectively formed between the ends of the rod parts; and
each second pivot protrusion further has an engaging panel formed between the second pivot protrusions of the second pivot portion and protruding into one of the clearances of the corresponding linkage.

7. The extension assembly for the sidebar as claimed in claim 1, wherein the mounting seat further has a connecting section formed on the inner end portion of the mounting seat and having at least one resilient abutting member.

8. The extension assembly for the sidebar as claimed in claim 4, wherein the mounting seat further has a connecting section formed on the inner end portion of the mounting seat and having at least one resilient abutting member.

9. The extension assembly for the sidebar as claimed in claim 7, wherein the connecting section of the mounting seat has
multiple mounting recesses linearly arranged on the mounting seat, and each mounting recess having a top opening and a bottom opening; and
multiple resilient abutting members respectively mounted in the mounting recesses and protruding out of the mounting recesses.

10. The extension assembly for the sidebar as claimed in claim 8, wherein the connecting section of the mounting seat has
multiple mounting recesses linearly arranged on the mounting seat, and each mounting recess having a top opening and a bottom opening; and
multiple resilient abutting members respectively mounted in the mounting recesses and protruding out of the mounting recesses.

11. The extension assembly for the sidebar as claimed in claim 4, wherein
each first pivot portion of the mounting seat further has two positioning fins formed oppositely beside the sliding space, and each positioning fin has a thickness increasing from top to bottom; and
a width of the sliding space of each first pivot portion of the mounting seat enlarges from bottom to top.

12. The extension assembly for the sidebar as claimed in claim 5, wherein
each first pivot portion of the mounting seat further has two positioning fins formed oppositely beside the sliding space, and each positioning fin has a thickness increasing from top to bottom; and
a width of the sliding space of each first pivot portion of the mounting seat enlarges from bottom to top.

13. The extension assembly for the sidebar as claimed in claim 6, wherein
each first pivot portion of the mounting seat further has two positioning fins formed oppositely beside the sliding space, and each positioning fin has a thickness increasing from top to bottom; and
a width of the sliding space of each first pivot portion of the mounting seat enlarges from bottom to top.

14. The extension assembly for the sidebar as claimed in claim 1, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

15. The extension assembly for the sidebar as claimed in claim 4, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

16. The extension assembly for the sidebar as claimed in claim 7, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

17. The extension assembly for the sidebar as claimed in claim 8, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

18. The extension assembly for the sidebar as claimed in claim 11, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

19. The extension assembly for the sidebar as claimed in claim 12, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.

20. The extension assembly for the sidebar as claimed in claim 13, wherein
the connecting portion of the sliding cover has
a first connecting panel having a proximal end, a distal end, and an inner surface;
a second connecting panel corresponding in position to and disposed apart from the first connecting panel, and the second connecting panel having
a proximal end connected with the proximal end of the first connecting panel;
a distal end; and
an inner surface facing the inner surface of the first connecting panel;
an insertion slot formed between the first connecting panel and the second connecting panel; and
an engaging protrusion formed on one of the inner surfaces of the first connecting panel and the second connecting panel; and
the connector has
a guiding portion having two ends;
a proximal connecting portion formed on one of the ends of the guiding portion, inserted in the insertion slot of the connecting portion of the sliding cover, and having a plate with an engaging hole, and the engaging hole engaging with the engaging protrusion of the connecting portion of the sliding cover; and
a distal connecting portion formed on the other end of the guiding portion.
